(19) United States
(12) Patent Application Publication
(10) Pub. No.: US 2024/0343152 A1
(43) Pub. Date: Oct. 17, 2024

(54) CONTROL APPARATUS AND CONTROL METHOD

(71) Applicant: TOYOTA JIDOSHA KABUSHIKI KAISHA, Toyota-shi (JP)

(72) Inventors: Chikage KUBO, Tokyo (JP); Masatoshi TERADA, Yamato-shi (JP)

(73) Assignee: TOYOTA JIDOSHA KABUSHIKI KAISHA, Toyota-shi (JP)

(21) Appl. No.: 18/634,546

(22) Filed: Apr. 12, 2024

(30) Foreign Application Priority Data
Apr. 14, 2023 (JP) 2023-066651

(51) Int. Cl. B60L 53/66; B60L 53/30

(52) U.S. Cl. CPC B60L 53/66; B60L 53/305

(57) ABSTRACT

A control apparatus includes a control unit that: displays a link that connects to a user registration site on a first server owned by a charging service operator running a charging stand on a display screen of a vehicle when stopping of the vehicle is detected in a predetermined zone including the charging stand; displays a registration screen in the user registration site on the display screen when the link is selected by the user driving the vehicle; imports vehicle identification information saved in the vehicle or user identification information saved in a second server owned by an operator providing a service other than charging to the user driving the vehicle onto the registration screen; and completes user registration when an examination result indicating that user registration has been accepted and a registration button are displayed on the registration screen and the registration button is selected by the user.

### CROSS-REFERENCE TO RELATED APPLICATION

This application claims priority to Japanese Patent Application No. 2023-066651 filed on Apr. 14, 2023, incorporated herein by reference in its entirety.

### BACKGROUND

### 1. Technical Field

The present disclosure relates to a control apparatus and a control method.

### 2. Description of Related Art

Hitherto, a technology relating to electronic settlement performed by a remote operation from a vehicle has been known. For example, in Japanese Unexamined Patent Application Publication No. 2009-140045, an in-vehicle product purchase system that purchases a product by a remote operation from a vehicle is disclosed. When the disclosure is carried out, it becomes possible to demand a charging fee from a vehicle that has received a charging service via an electronic settlement system when identification information of the vehicle is registered in a server of a business operator that operates a charging stand.

### SUMMARY

However, in order to use the charging service, a user and a vehicle need to be registered in advance. Therefore, when a user uses the charging service for the first time or when a vehicle is not registered in advance, the user needs to input information necessary for the registration of the vehicle each time, and the procedure has been complicated.

Therefore, there has been room for improvement in the technology relating to the electronic settlement performed by the remote operation from the vehicle.

An object of the present disclosure made in view of the situation described above is to improve a technology relating to electronic settlement performed by a remote operation from a vehicle.

A control apparatus according to one embodiment of the present disclosure is a control apparatus that performs user registration of a charging service. The control apparatus includes a control unit that: displays a link that connects to a user registration site on a first server owned by a charging service operator that runs a charging stand on a display screen of a vehicle when stopping of the vehicle is detected on the inner side of a predetermined zone including the charging stand; displays a registration screen in the user registration site on the display screen when the link is selected by a user that drives the vehicle; imports vehicle identification information saved in the vehicle or user identification information saved in a second server owned by an operator that provides a service other than charging to the user onto the registration screen; and completes the user registration when an examination result indicating that the user registration has been accepted and a registration button are displayed on the registration screen and the registration button is selected by the user.

A control method according to one embodiment of the present disclosure is a control method executed by a control apparatus that performs user registration of a charging service. The method includes: displaying a link that connects to a user registration site on a first server owned by a charging service operator that runs a charging stand on a display screen of a vehicle when stopping of the vehicle is detected on the inner side of a predetermined zone including the charging stand; displaying a registration screen in the user registration site on the display screen when the link is selected by a user that drives the vehicle; importing vehicle identification information saved in the vehicle or user identification information saved in a second server owned by an operator that provides a service other than charging to the user onto the registration screen; and completing the user registration when an examination result indicating that the user registration has been accepted and a registration button are displayed on the registration screen and the registration button is selected by the user.

According to one embodiment of the present disclosure, the technology relating to the electronic settlement performed by the remote operation from the vehicle is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to one embodiment of the present disclosure;

FIG. 2 is a flowchart showing an operation of a control apparatus;

FIG. 3 is a schematic diagram of the system according to one embodiment of the present disclosure; and

FIG. 4 is a schematic diagram showing a flow of user registration.

### DETAILED DESCRIPTION OF EMBODIMENTS

An embodiment of the present disclosure is described below.

### Overview of Embodiment

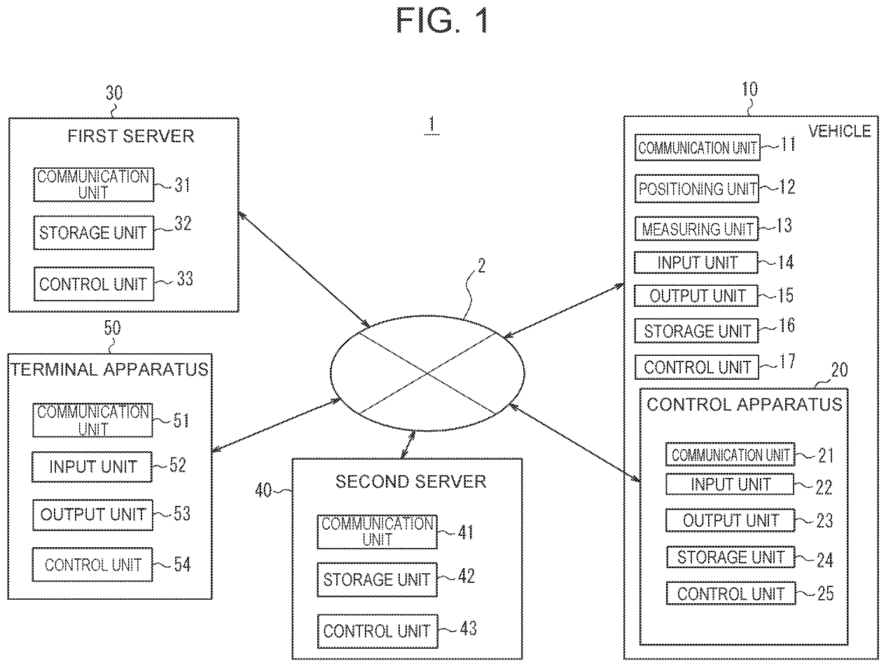

With reference to FIG. 1, an overview of a system 1 according to an embodiment of the present disclosure is described. The system 1 includes a vehicle 10, a control apparatus 20, a first server 30, a second server 40, and a terminal apparatus 50. The vehicle 10, the control apparatus 20, the first server 30, the second server 40, and the terminal apparatus 50 are communicably connected to a network 2 including the Internet, a mobile communication network, and the like, for example.

The vehicle 10 is an automobile that travels by a motor using electricity as a power source. The automobile may be a battery electric vehicle (BEV), a plug-in hybrid electric vehicle (PHEV), or the like but is not limited thereto. The number of the vehicles 10 included in the system 1 may be freely defined. The vehicle 10 is communicably connected to the control apparatus 20, the first server 30, the second server 40, and the terminal apparatus 50 via the network 2.

The control apparatus 20 is a computer mounted on the vehicle 10 and performs user registration of a charging service. The control apparatus 20 is communicably connected to the vehicle 10, the first server 30, the second server 40, and the terminal apparatus 50 via the network 2.

The first server 30 is a computer owned by a charging service operator that centrally manages charging stands located in a plurality of places. The first server 30 is communicably connected to the vehicle 10, the control apparatus 20, and the terminal apparatus 50 via the network 2.

The second server 40 is a computer owned by an operator that provides a service other than charging to the user that drives the vehicle 10. The operator that owns the second server 40 does not include the operator that provides the charging service. The second server 40 is communicably connected to the vehicle 10 and the control apparatus 20 via the network 2.

The terminal apparatus 50 is a computer installed in each of the plurality of charging stands run by the charging service operator. The terminal apparatus 50 calculates a charging fee by acquiring an electric power amount by which a charger has charged the vehicle 10. The terminal apparatus 50 is communicably connected to the vehicle 10, the control apparatus 20, and the first server 30 via the network 2.

First, an overview of the present embodiment is described, and details are described later. The control apparatus 20 displays a link that connects to a user registration site on the first server 30 owned by the charging service operator that runs a charging stand on a display screen of the vehicle 10 when stopping of the vehicle 10 is detected on the inner side of a predetermined zone including the charging stand, displays a registration screen in the user registration site on the display screen when the link is selected by the user that drives the vehicle 10, imports vehicle identification information saved in the vehicle 10 or user identification information saved in the second server 40 owned by an operator that provides a service other than charging to the user onto the registration screen, and completes the user registration when an examination result indicating that the user registration has been accepted and a registration button are displayed on the registration screen and the registration button is selected by the user.

As above, according to the present embodiment, the control apparatus 20 can import the vehicle identification information saved in the vehicle 10 or the user identification information saved in the second server 40 to the registration screen in the user registration site of the first server 30 of the charging service operator. Therefore, the effort and time for a user that uses the charging service for the first time or the user that drives the vehicle 10 that is not registered in advance to perform user registration with respect to the charging service operator are reduced. Therefore, a technology relating to electronic settlement performed by the remote operation from the vehicle 10 is improved in terms of improving the probability of an unregistered user being able to easily use the charging stand.

Next, each configuration of the system 1 is described in detail.

### Configuration of Vehicle

As shown in FIG. 1, the vehicle 10 includes a communication unit 11, a positioning unit 12, a measuring unit 13, an output unit 15, a storage unit 16, a control unit 17, and the control apparatus 20. The configuration of the control apparatus 20 is described later.

The communication unit 11 includes one or more communication interfaces to be connected to the network 2. The communication interface corresponds to mobile communication standards such as 4th generation (4G) or 5th generation (5G), an in-vehicle network (for example, a controller area network (CAN)), or the like, for example, but is not limited thereto. In the present embodiment, the vehicle 10 communicates with the control apparatus 20, the first server 30, the second server 40, and the terminal apparatus 50 via the communication unit 11 and the network 2. The vehicle 10 may communicate with the control apparatus 20 in the vehicle 10 by the CAN, for example, via the communication unit 11.

The positioning unit 12 includes one or more apparatuses that acquire positional information of the vehicle 10. Specifically, the positioning unit 12 includes a receiving machine corresponding to a GPS, for example, but is not limited thereto and may include a receiving machine corresponding to a freely-selected satellite positioning system. 20

The measuring unit 13 includes one or more apparatuses that monitor vehicle states such as a traveling speed of the vehicle 10. Specifically, one or more apparatuses are a pressure sensor, an exhaust gas sensor, an acceleration sensor, a gyroscope sensor, a millimeter-wave radar, an infrared radar, a camera, or the like and measure and collect data inside and outside the vehicle 10. However, one or more apparatuses are not 25 limited thereto.

An input unit 14 includes at least one input interface capable of accepting an input from the user that drives the vehicle 10. The input interface is a physical key, a capacitance key, a pointing device, a touch screen integrally provided with a display of the output unit 15 described later, or a microphone to which a voice of the user is input, for example. However, the input interface is not limited thereto.

The output unit 15 includes at least one voice output interface capable of outputting voice and at least one display interface capable of displaying characters or a moving image. The voice output interface is a speaker, for example. The display interface is a display such as an LCD or an organic EL display, for example. The output unit 15 displays the link that connects to the user registration site on the first server 30 of the charging service operator and the registration screen in the user registration site described later. The voice output interface and the display interface are not limited thereto.

The storage unit 16 includes one or more memories. The memory is a semiconductor memory, a magnetic memory, or an optical memory, for example, but is not limited thereto. Each memory included in the storage unit 16 may function as a main storage apparatus, an auxiliary storage apparatus, or a cache memory, for example. The storage unit 16 stores therein freely-selected information used in the operation of the vehicle 10. For example, the storage unit 16 may store therein a system program, an application program, embedded software, the vehicle identification information described later, positional information of the charging stand located in a traveling-scheduled region acquired from the first server 30 described later, and the like. The information stored in the storage unit 16 may be updatable by information acquired from the network 2 via the communication unit 11, for example.

The control unit 17 includes one or more processors, one or more programmable circuits, one or more dedicated circuits, or a combination thereof. The processor is a general-purpose processor such as a central processing unit (CPU) or a graphics processing unit (GPU), or a dedicated processor specialized in predetermined processing, for example, but is not limited thereto. The programmable circuit is a field-programmable gate array (FPGA), for example, but is not limited thereto. The dedicated circuit is an application specific integrated circuit (ASIC), for example, but is not limited thereto. The control unit 17 controls the operation of the entire vehicle 10.

### Configuration of Control Apparatus

As shown in FIG. 1, the control apparatus 20 includes a communication unit 21, an input unit 22, an output unit 23, a storage unit 24, and a control unit 25.

The communication unit 21 includes one or more communication interfaces to be connected to the network 2. The communication interface corresponds to a mobile communication standard, a wired local area network (LAN) standard, a wireless LAN standard, or an in-vehicle network (for example, a CAN), for example, but is not limited thereto and may correspond to a freely-selected communication standard. In the present embodiment, the control apparatus 20 communicates with the vehicle 10, the first server 30, the second server 40, and the terminal apparatus 50 via the communication unit 21 and the network 2. The control apparatus 20 may communicate with the vehicle 10 by the CAN, for example, via the communication unit 21.

The input unit 22 includes at least one input interface capable of accepting an input from the user that drives the vehicle 10. The input interface is a physical key, a capacitance key, a pointing device, a touch screen integrally provided with a display of the output unit 23 described later, or a microphone to which a voice of the user is input, for example. However, the input interface is not limited thereto.

The output unit 23 includes at least one voice output interface capable of outputting voice and at least one display interface capable of displaying characters or a moving image. The voice output interface is a speaker for responding to the user by a voice, for example. The display interface is a display such as an LCD or an organic EL display, for example. The output unit 23 displays the link that connects to the user registration site on the first server 30 of the charging service operator and the registration screen in the user registration site described later. However, the voice output interface and the display interface are not limited thereto.

The storage unit 24 includes one or more memories. Each memory included in the storage unit 24 may function as a main storage apparatus, an auxiliary storage apparatus, or a cache memory, for example. The storage unit 24 stores therein freely-selected information used in the operation of the control apparatus 20. For example, the storage unit 24 may store therein a system program, an application program, a database, information of the link that connects to the user registration site on the first server 30 described later, and the like in advance. The information stored in the storage unit 24 may be updatable by information acquired from the network 2 via the communication unit 21, for example.

The control unit 25 includes one or more processors, one or more programmable circuits, one or more dedicated circuits, or a combination thereof. The control unit 25 controls the operation of the entire control apparatus 20.

### Configuration of First Server

As shown in FIG. 1, the first server 30 includes a communication unit 31, a storage unit 32, and a control unit 33.

The communication unit 31 includes one or more communication interfaces to be connected to the network 2. The communication interface corresponds to a wired LAN standard or a wireless LAN standard, for example, but is not limited thereto and may correspond to a freely-selected communication standard. In the present embodiment, the first server 30 communicates with the vehicle 10, the control apparatus 20, and the terminal apparatus 50 via the communication unit 31 and the network 2.

The storage unit 32 includes one or more memories. Each memory included in the storage unit 32 may function as a main storage apparatus, an auxiliary storage apparatus, or a cache memory, for example. The storage unit 32 stores therein freely-selected information used in the operation of the first server 30. For example, the storage unit 32 may store therein a system program, an application program, a database, a program that examines the vehicle identification information or the user identification information described later, registered vehicle identification information or user identification information, and the like. The information stored in the storage unit 32 may be updatable by information acquired from the network 2 via the communication unit 31, for example.

The control unit 33 includes one or more processors, one or more programmable circuits, one or more dedicated circuits, or a combination thereof. The control unit 33 controls the operation of the entire first server 30.

### Configuration of Second Server

As shown in FIG. 1, the second server 40 includes a communication unit 41, a storage unit 42, and a control unit 43.

The communication unit 41 includes one or more communication interfaces to be connected to the network 2. The communication interface corresponds to a wired LAN standard or a wireless LAN standard, for example, but is not limited thereto and may correspond to a freely-selected communication standard. In the present embodiment, the second server 40 communicates with the vehicle 10 and the control apparatus 20 via the communication unit 41 and the network 2.

The storage unit 42 includes one or more memories. Each memory included in the storage unit 42 may function as a main storage apparatus, an auxiliary storage apparatus, or a cache memory, for example. The storage unit 42 stores therein freely-selected information used in the operation of the second server 40. For example, the storage unit 42 may store therein a system program, an application program, a database, the user identification information of the user to which the operator that owns the second server 40 provides a service, and the like. The information stored in the storage unit 42 may be updatable by information acquired from the network 2 via the communication unit 41, for example.

The control unit 43 includes one or more processors, one or more programmable circuits, one or more dedicated circuits, or a combination thereof. The control unit 43 controls the operation of the entire second server 40.

### Configuration of Terminal Apparatus

As shown in FIG. 1, the terminal apparatus 50 includes a communication unit 51, an input unit 52, an output unit 53, and a control unit 54.

The communication unit 51 includes one or more communication interfaces to be connected to the network 2. The communication interface corresponds to a wired LAN standard or a wireless LAN standard, for example, but is not limited thereto and may correspond to a freely-selected communication standard. In the present embodiment, the terminal apparatus 50 communicates with the vehicle 10, the control apparatus 20, and the first server 30 via the communication unit 51 and the network 2. The terminal apparatus 50 is connected to the charger by a wired LAN standard or a wireless LAN standard, for example.

The input unit 52 includes at least one input interface capable of accepting an input from the user. The input interface is a physical key, a capacitance key, a pointing device, a touch screen integrally provided with a display, a card reader that reads a member card/credit card, or a microphone, for example. However, the input interface is not limited thereto.

The output unit 53 can output data. The output unit 53 includes at least one output interface capable of outputting data. The output interface is a display screen (display), a speaker, or a printer that prints documents such as a detailed statement/receipt, for example. The display screen is an LCD or an organic EL display, for example. However, the output interface is not limited thereto.

The control unit 54 includes one or more processors, one or more programmable circuits, one or more dedicated circuits, or a combination thereof. The control unit 54 controls the operation of the entire terminal apparatus 50.

### Operation Flow of Information Processing Apparatus

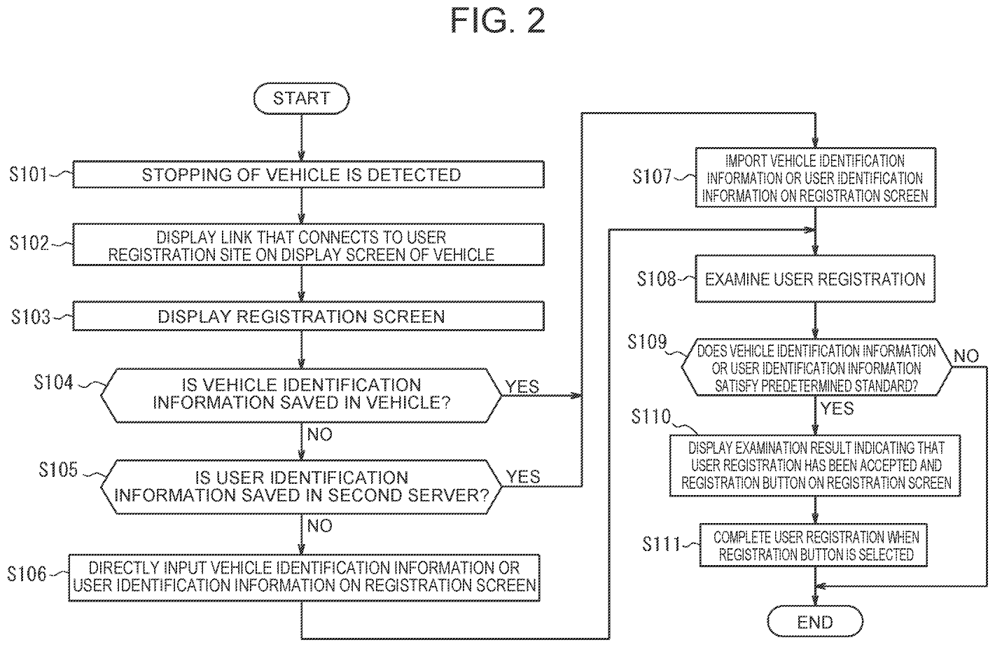

The operation of the control apparatus 20 according to the present embodiment is described with reference to a flowchart shown in FIG. 2. The present operation relates to the user registration of the charging service.

Step S101: The control unit 17 of the vehicle 10 detects the stopping of the vehicle 10 on the inner side of a predetermined zone 3 including a charging stand 4.

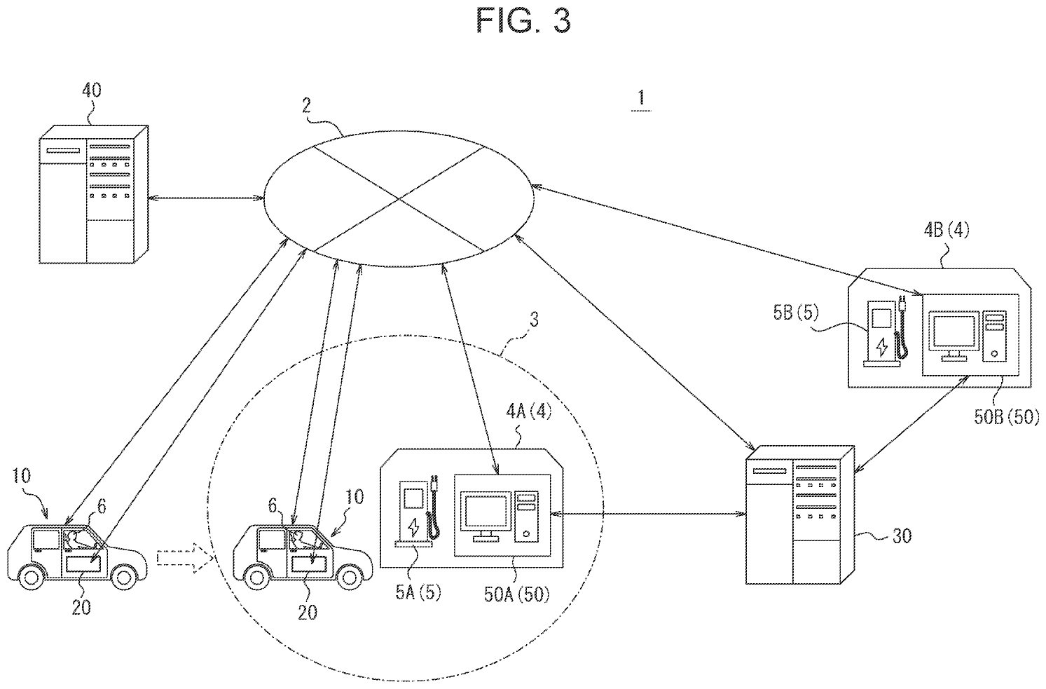

FIG. 3 is a schematic diagram of the system according to one embodiment of the present disclosure. As shown in FIG. 3, the vehicle 10 enters and stops on the inner side of the predetermined zone 3 including a charging stand 4A in order to be charged by a charger 5A.

The stopping of the vehicle 10 may include traveling at a predetermined traveling speed or less, for example, driving slowly to enter premises of the charging stand 4. The positioning unit 12 measures the location of the vehicle 10. The measuring unit 13 measures the traveling speed of the vehicle 10. When the control unit 17 detects that the vehicle 10 is moving at a predetermined traveling speed or less or stopping on the inner side of the predetermined zone 3, the control unit 17 transmits the detected information to the control apparatus 20.

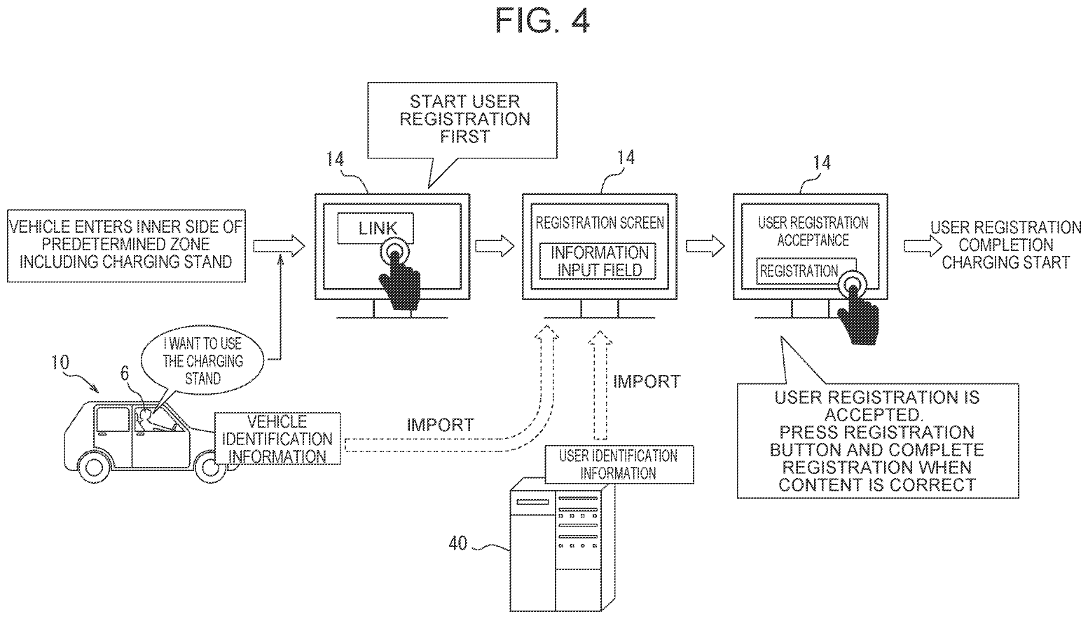

The control apparatus 20 may further include the input unit 22 that accepts an input by a voice from a user 6 that drives the vehicle 10, and the output unit 23 that responds to the user 6 by a voice. As shown in FIG. 4, the control apparatus 20 performs user registration by a conversation with the user 6.

Step S102: The control unit 25 displays a link that connects to the user registration site on the first server 30 owned by the charging service operator that runs the charging stand 4 on the display screen of the vehicle 10.

The storage unit 24 may save an information list of the link that connects to the user registration site on the server (including the first server 30 in the present embodiment) of the charging service operator in advance. The control unit 25 displays a link that connects to the user registration site on the first server 30 saved in the storage unit 24 on the display screen of the vehicle 10 via the communication unit 21 and the communication unit 11. In the present embodiment, description is made hereinafter by considering that the link is a URL, but the link is not limited to a URL.

Step S103: The control unit 25 displays the registration screen in the user registration site on the display screen when the link (URL) is selected by the user 6 that drives the vehicle 10.

When the URL is selected by the user 6 that drives the vehicle 10, the control unit 25 activates a browser application or a dedicated application installed in the vehicle 10 and displays the registration screen in the user registration site on the display screen. In the present embodiment, description is hereinafter made by considering that the display screen of the vehicle 10 is a touch screen integrally provided with the display and that the selection of the URL is an operation of tapping the display screen, but the type of the display screen and the method of selecting the URL are not limited thereto.

As shown in Steps S101 to S103, the control unit 25 may automatically start a procedure of the user registration with the trigger of detecting the stopping of the vehicle 10 on the inner side of the predetermined zone 3 including the charging stand 4.

Meanwhile, as shown in FIG. 4, when the input unit 22 accepts an input by a voice from the user 6 saying that the user 6 wants to use the charging stand, the output unit 23 of the control apparatus 20 may guide the user 6 to tap a link (URL) that connects to the user registration site and start the user registration by a voice. According to such configuration, the control apparatus 20 can passively start the procedure of the user registration by a conversation with the user 6. In FIG. 4, an oval speech bubble indicates asking by the voice of the user 6, and a rectangular speech bubble indicates a response by a voice from the output unit 23. The registration screen is displayed when the user 6 taps the URL in accordance with the response by the voice from the output unit 23.

Step S104: The control unit 25 confirms whether the vehicle identification information is saved in the vehicle 10. The process proceeds to Step S107 when the vehicle identification information is saved, and the process proceeds to Step S105 when the vehicle identification information is not saved.

The vehicle identification information includes settlement registration information and vehicle information of the vehicle 10. The vehicle information is information such as an automobile registration number or a vehicle number, a vehicle name, a chassis number, a model, a full name or a name, an address, and an automobile license number/validity period of the user that drives the vehicle 10, for example, but is not limited thereto. The settlement registration information is information of settlement means such as a credit card used in the payment of a fee by the user that drives the vehicle 10, for example. When the vehicle 10 is a vehicle owned by the user 6, the vehicle identification information is desired to be saved in the storage unit 16 of the vehicle 10 in advance. When the vehicle identification information is saved in the vehicle 10, the user registration can be performed for each vehicle 10.

Step S105: The control unit 25 confirms whether the user identification information of the user 6 is saved in the second server 40 of the operator that provides a service to the user 6 that drives the vehicle 10. The process proceeds to Step S107 when the user identification information is saved, and the process proceeds to Step S106 when the user identification information is not saved.

The operator that owns the second server 40 is an automobile sales company that sells the vehicle 10 to the user 6 and provides a vehicle maintenance service, a delivery service operator, or a wireless communication operator that provides a mobile phone service, for example, but is not limited thereto.

The user identification information includes settlement registration information and user account information of the user 6 that drives the vehicle 10. The user account information is information such as an address, a full name or a name, an age, and an automobile license number/validity period of the user 6 registered on the second server 40 of the operator from which the user 6 receives a service, for example, but is not limited thereto.

The settlement registration information is information of settlement means such as a credit card used in the payment of a fee by the user 6, for example. When the user identification information is saved in the second server 40, the user registration can be performed for each user (user account) instead of each vehicle 10. When the vehicle 10 is a rental car or a shared car, for example, and is not a vehicle owned by the user 6, the convenience for the user 6 to perform user registration increases when the user registration can be performed by the user identification information instead of the vehicle identification information.

Step S106: The control unit 25 prompts the user 6 to directly input the vehicle identification information or the user identification information onto the registration screen when the vehicle identification information is not saved in the vehicle 10 and the user identification information is not saved in the second server 40.

The control unit 25 may accept the vehicle identification information or the user identification information by a conversation with the user 6. In such a case, the output unit 23 asks the user 6 for the identification information, the input unit 22 accepts the voice input of the user 6, and the control unit 25 inputs the identification information onto the registration screen. The convenience for the user 6 to perform the user registration increases with use of the voice input.

Step S107: The control unit 25 imports the vehicle identification information necessary for the user registration saved in the vehicle 10 or the user identification information necessary for the user registration saved in the second server owned by the operator that provides a service other than the charging to the user that drives the vehicle 10 onto the registration screen.

The control unit 25 may provide an option (one-time registration) of removing the user registration when the vehicle 10 is charged once. It becomes easier to switch the setting back to the original setting when the vehicle 10 is returned when “one-time registration” can be selected when the vehicle 10 driven by the user is a rental car or a shared car, for example.

Step S108: The control unit 33 of the first server 30 examines whether the user registration is possible on the basis of the vehicle identification information or the user identification information input onto the registration screen.

Step S109: The control unit 33 examines whether the input vehicle identification information or user identification information satisfies a predetermined standard. The process proceeds to Step S110 when the vehicle identification information or the user identification information satisfies the predetermined standard, and the user registration is rejected and the process is ended when the vehicle identification information or the user identification information does not satisfy the predetermined standard.

The predetermined standard is a standard for determining a validity period of an automobile license of the user 6 included in the vehicle information or the user account information, and credit information such as the usage history and the payment status of a credit card that is the settlement registration information, for example. The control unit 33 accepts the user registration when the identification information satisfies the predetermined standard and rejects the user registration when the identification information does not satisfy the predetermined standard.

Step S110: The control unit 33 of the first server 30 displays an examination result indicating that the user registration has been accepted and a registration button on the registration screen.

As shown in FIG. 4, when the user registration is accepted, the control unit 33 of the first server 30 displays the examination result indicating that the user registration is accepted and the registration button for causing the user 6 to reconfirm the registration content on the registration screen. At this time, the output unit 23 of the control apparatus 20 may perform guidance by a voice saying that “User registration is accepted. Press registration button and complete registration when content is correct”. The content of the voice guidance is not limited to the content described above.

Step S111: The control unit 25 of the control apparatus 20 completes the user registration when the registration button is selected by the user 6. Then, the process of the user registration ends, and the user 6 starts charging to the vehicle 10.

The user 6 that does not perform the user registration needs to input the vehicle identification information or the user identification information onto the terminal apparatus 50 for each time of charging. It has taken time and effort, and the procedure has been complicated. However, the user 6 that has completed the user registration can use the charging service by simply inputting a user ID and a password acquired by the user registration and logging into the user site on the first server 30 and applying for charging.

FIG. 3 is referred to again. When the user registration is completed, the user 6 that drives the vehicle 10 logs into the user site on the first server 30 by inputting the user ID and the password and applies for the charging. When the first server 30 confirms the validity of the user registration on the basis of the user ID of the user 6, the first server 30 allows the vehicle 10 to perform charging. When the charging ends, a terminal apparatus 50A connected to the first server 30 calculates a charging fee by acquiring the electric power amount charged to the vehicle 10 by the charger 5A. The terminal apparatus 50A demands the charging fee from the credit card registered as the settlement registration information. As shown in FIG. 3, the first server 30 centrally manages the terminal apparatuses 50 (50A, 50B . . . ) installed in the plurality of charging stands 4 (4A, 4B . . . ) via the network 2.

As described above, the control apparatus 20 according to the present embodiment displays the link that connects to the user registration site on the first server 30 owned by the charging service operator that runs the charging stand 4 on the display screen of the vehicle 10 when stopping of the vehicle 10 is detected on the inner side of the predetermined zone 3 including the charging stand 4, displays the registration screen in the user registration site on the display screen when the link is selected by the user 6 that drives the vehicle 10, imports the vehicle identification information saved in the vehicle 10 or the user identification information saved in the second server 40 owned by the operator that provides a service other than charging to the user that drives the vehicle 10 onto the registration screen, and completes the user registration when the examination result indicating that the user registration has been accepted and the registration button are displayed on the registration screen and the registration button is selected by the user 6.

According to such a configuration, the control apparatus 20 can cause the vehicle identification information saved in the vehicle 10 or the user identification information saved in the second server 40 to be imported to the registration screen in the user registration site of the first server 30 of the charging service operator. Therefore, the effort and time for a user that uses the charging service for the first time or the user that drives the vehicle 10 that is not registered in advance to perform user registration with respect to the charging service operator are reduced. Therefore, a technology relating to electronic settlement by the remote operation from the vehicle 10 is improved in terms of improving the probability of an unregistered user being able to easily use the charging stand.

The present disclosure has been described on the basis of the drawings and examples, but note that a person skilled in the art may make various modifications and changes on the basis of the present disclosure. Therefore, note that those modifications and changes are included in the range of the present disclosure. For example, a function and the like included in cach configuration unit, each step, and the like can be rearranged so as to be logically consistent, and a plurality of configuration units, steps, and the like can be combined or divided.

For example, in the embodiment described above, an embodiment in which the configuration and the operation of the control apparatus 20 are distributed to a plurality of computers that can communicate with each other is also possible. For example, an embodiment in which some or all components of the control apparatus 20 are provided in the vehicle 10 is also possible. Function units (the communication unit 11, the input unit 14, the output unit 15, the storage unit 16, and the control unit 17) included in the vehicle 10 may include some or all components of the control apparatus 20. For example, the input unit 14 of the vehicle 10 may receive asking by the voice of the user 6, and the output unit 15 may respond to the user 6 by a voice.

For example, an embodiment in which a general-purpose computer functions as the control apparatus 20 according to the embodiment described above is also possible. Specifically, a program in which processing content for realizing each function of the control apparatus 20 according to the embodiment described above is stored in a memory of the general-purpose computer, and the program is executed by being read out by the processor. Therefore, the present disclosure can also be realized as a program executable by a processor or a non-transitory computer-readable medium that stores the program therein.

What is claimed is:

1. A control apparatus that performs a user registration of a charging service, the control apparatus comprising a control unit that:
displays a link that connects to a user registration site on a first server owned by a charging service operator that runs a charging stand on a display screen of a vehicle when stopping of the vehicle is detected on an inner side of a predetermined zone including the charging stand;
displays a registration screen in the user registration site on the display screen when the link is selected by a user that drives the vehicle;
imports vehicle identification information saved in the vehicle or user identification information saved in a second server owned by an operator that provides a service other than charging to the user onto the registration screen; and
completes the user registration when an examination result indicating that the user registration has been accepted and a registration button are displayed on the registration screen and the registration button is selected by the user.

2. The control apparatus according to claim 1, wherein the user registration is removed when the vehicle is charged once.

3. The control apparatus according to claim 1, further comprising:
an input unit that accepts an input by a voice from the user; and
an output unit that responds to the user by a voice.

4. The control apparatus according to claim 3, wherein the output unit guides the link that connects to the user registration site to be selected and the user registration to be started by a voice when the input unit accepts an input by a voice wanting to use the charging stand from the user.

5. A control method executed by a control apparatus that performs user registration of a charging service, the method comprising:
displaying a link that connects to a user registration site on a first server owned by a charging service operator that runs a charging stand on a display screen of a vehicle when stopping of the vehicle is detected on an inner side of a predetermined zone including the charging stand;
displaying a registration screen in the user registration site on the display screen when the link is selected by a user that drives the vehicle;
importing vehicle identification information saved in the vehicle or user identification information saved in a second server owned by an operator that provides a service other than charging to the user onto the registration screen; and
completing the user registration when an examination result indicating that the user registration has been accepted and a registration button are displayed on the registration screen and the registration button is selected by the user.
